(19) United States
(12) Patent Application Publication
(10) Pub. No.: US 2022/0285766 A1
(43) Pub. Date: Sep. 8, 2022

(54) CELL AND ELECTRICAL APPARATUS

(71) Applicant: Ningde Amperex Technology Limited, Ningde City (CN)

(72) Inventor: Xuecheng Li, Ningde City (CN)

(73) Assignee: Ningde Amperex Technology Limited, Ningde City (CN)

(21) Appl. No.: 17/683,525

(22) Filed: Mar. 1, 2022

(30) Foreign Application Priority Data
Mar. 4, 2021 (CN) 202110237021.5

(51) Int. Cl. H01M 50/183

(52) U.S. Cl. CPC H01M 50/183

(57) ABSTRACT

A cell includes an electrode assembly, a housing, tabs, a first sealant, and a second sealant. The housing includes a housing body and a sealing portion connected to the housing body. The sealing portion is disposed between the first side surface and the second side surface. The tabs protrude from the sealing portion and include a first tab and a second tab. The first sealant is used to sealably connect the first tab and the sealing portion. The second sealant is used to sealably connect the second tab and the sealing portion. The sealing portion between the first sealant and the first side surface is a first sealing portion, and the sealing portion between the first sealant and the second sealant is a second sealing portion. In a length direction of the housing, a width of the first sealing portion is greater than a width of the second sealing portion.

### CROSS-REFERENCE TO RELATED APPLICATIONS

This application claims benefit of priority from Chinese Patent Application No. 202110237021.5, filed on Mar. 3, 2021, which is incorporated herein by reference in its entirety.

### TECHNICAL FIELD

This application relates to the field of energy storage technologies, and in particular, to a cell and an electrical apparatus having the cell.

### BACKGROUND

With the mature application of consumer electronic products, customers pay more attention to a risk of using the machines. For example, an increasingly high requirement is imposed on drop resistance of the electronic products. As an important component of the electronic products, a cell is also required to have drop resistance.

During preparation of a cell, aluminum-plastic films at upper and lower layers need to be heat sealed by using a sealing head, so that a bare cell and an electrolyte are sealed inside the aluminum-plastic films. However, when the cell drops, the bare cell and the free electrolyte move in the same direction as the dropping direction of the cell. At the moment when the cell hits the ground, the cell will bounce, while the bare cell and the free electrolyte will continue moving due to inertia, thus causing an impact on a sealed edge of the aluminum-plastic film. As a result, the sealed edge is likely to break, leading to risks such as electrolyte leakage or fire due to a short circuit, causing cell failure, and reducing use safety of the cell.

### SUMMARY

In order to resolve the above shortcomings of the prior art, it is necessary to provide a cell.

In addition, it is also necessary to provide an electrical apparatus having the foregoing cell.

An embodiment of this application provides a cell, the cell includes an electrode assembly, a housing, tabs, a first sealant, and a second sealant. The housing includes a housing body that accommodates the electrode assembly and a sealing portion that is connected to the housing body. The housing body includes a first side surface and a second side surface opposite to the first side surface. In a width direction of the housing, the sealing portion is disposed between the first side surface and the second side surface. A plurality of tabs protrude from the sealing portion, and the plurality of tabs include a first tab and a second tab that are arranged side by side. The first sealant is used to sealably connect the first tab and the sealing portion, and a portion of the first sealant is disposed outside the sealing portion. The second sealant is used to sealably connect the second tab and the sealing portion, and a portion of the second sealant is disposed outside the sealing portion. The sealing portion between the first sealant and the first side surface is a first sealing portion, and the sealing portion between the first sealant and the second sealant is a second sealing portion. In a length direction of the housing, a width of the first sealing portion is greater than a width of the second sealing portion.

In some possible embodiments, in the length direction of the housing, an outer periphery of the first sealing portion does not exceed an outer periphery of the second sealing portion exposed outside the first sealant.

In some possible embodiments, in the length direction of the housing, the width of the first sealing portion is greater than a width of the sealing portion between the first tab and the second tab.

In some possible embodiments, the sealing portion between the second sealant and the second side surface is a third sealing portion. In the length direction of the housing, a width of the third sealing portion is greater than the width of the second sealing portion.

In some possible embodiments, in the length direction of the housing, an outer periphery of the third sealing portion does not exceed an outer periphery of the second sealing portion exposed outside the second sealant.

In some possible embodiments, in the length direction of the housing, the width of the third sealing portion is greater than a width of the sealing portion between the first tab and the second tab.

In some possible embodiments, the sealing portion further includes a fourth sealing portion. In the width direction of the housing, the second sealing portion between the first sealant and the second sealant extends along a protrusion direction of the first tab or the second tab to form the fourth sealing portion.

In some possible embodiments, in the length direction of the housing, a width of the fourth sealing portion is less than or equal to a width of the second sealing portion exposed outside the first sealant, and is less than or equal to a width of the second sealing portion exposed outside the second sealant. In the width direction of the housing, a length of the fourth sealing portion is less than a distance between an end of the first sealant that is close to the second tab and an end of the second sealant that is close to the first tab.

In some possible embodiments, in the length direction of the housing, a sum of the width of the second sealing portion and a width of the fourth sealing portion is less than the width of the first sealing portion or the third sealing portion.

An embodiment of this application further provides an electrical apparatus, including the cell described in any one of the foregoing embodiments.

In this application, the width of the first sealing portion between the first sealant and the first side surface is made greater than the width of the second sealing portion between the first sealant and the second sealant, which increases the width of the sealing portion between the first sealant and the first side surface, thereby increasing a sealing strength of this part of sealing portion accordingly. When mechanical abuse of the cell occurs, an impact resistance of the electrode assembly and an electrolyte at this part of sealing portion increases, and a stroke required for the electrode assembly and the electrolyte to fully break this part of sealing portion also increases. This reduces a possibility of breaking this part of sealing portion, reduces a risk of cell failure, and improves safety performance of the cell. Further, despite the increased width, the sealing portion between the first sealant and the first side surface does not occupy an inner space of the housing body of the housing, thereby avoiding loss of energy density of the cell caused by the increase in the width of this part of sealing portion.

### BRIEF DESCRIPTION OF DRAWINGS

FIG. 1 is a schematic structural diagram of a cell according to an embodiment of this application;

FIG. 2 is a cross-sectional view of a packaging film of a cell housing shown in FIG. 1;

FIG. 3 is a partial cross-sectional view of the cell shown in FIG. 1 along according to an embodiment;

FIG. 4 is a partial cross-sectional view of the cell shown in FIG. 1 along according to another embodiment;

FIG. 5 is a schematic structural diagram of a cell according to another embodiment of this application;

FIG. 6 is a schematic structural diagram of an electrical apparatus according to an embodiment of this application.

### REFERENCE SIGNS OF MAIN COMPONENTS

Electrical apparatus 1
Housing 10
Housing body 11
Sealing portion 12
First tab 20
Second end 21
First sealant 30
Second tab 40
Fourth end 41
Second sealant 50
Cell 100 and 200
Packaging film 110
First packaging film 110a
Second packaging film 110b
Protective layer 111
First binding layer 112
Metal layer 113
Second binding layer 114
Packaging layer 115
Top surface 116
Bottom surface 117
First side surface 118
Second side surface 119
First sealing portion 121
Second sealing portion 122
Third sealing portion 123
Fourth sealing portion 124
Unsealed portion 125
Length L₁ to L₃
Width W₁ to W₈

This application will be further described with reference to the accompanying drawings in the following specific embodiments.

### DETAILED DESCRIPTION

The following clearly describes the technical solutions in the embodiments of this application with reference to the accompanying drawings in the embodiments of this application. Apparently, the described embodiments are only some rather than all of the embodiments of this application.

Unless otherwise defined, all technical and scientific terms used herein shall have the same meanings as commonly understood by those skilled in the art to which this application belongs. The terms used herein in the specification of this application are only used to describe specific embodiments, and are not intended to limit this application.

The following describes in detail some embodiments of this application with reference to the accompanying drawings. In absence of conflicts, the following embodiments and features in the embodiments may be combined.

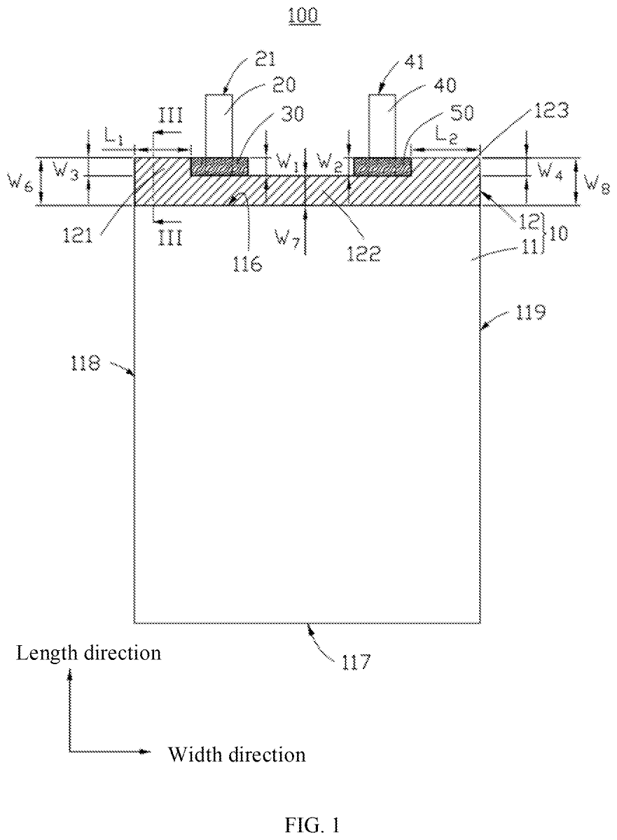

Referring to FIG. 1, an embodiment of this application provides a cell 100, including a housing 10, an electrode assembly (not shown), an electrolyte (not shown), tabs, a first sealant 30, and a second sealant 50.

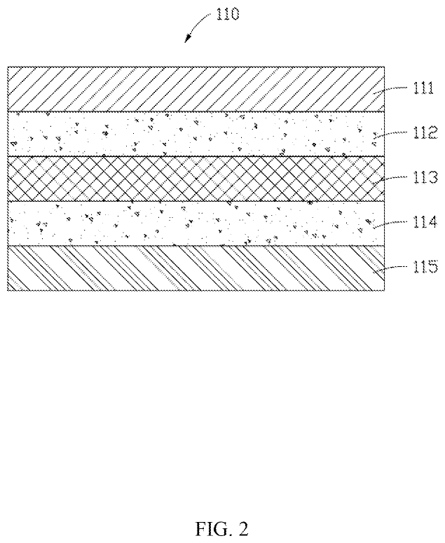

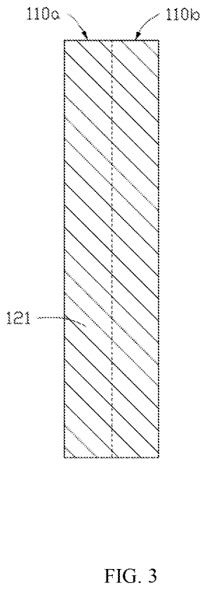

The housing 10 includes a housing body 11 and a sealing portion 12 connected to the housing body 11. The housing body 11 is used to accommodate the electrode assembly and the electrolyte. Also referring to FIG. 2, in an embodiment, the housing 10 is a packaging bag obtained by packaging with a packaging film 110, which means the cell 100 is a soft package cell. The packaging film 110 includes a protective layer 111, a first binding layer 112, a metal layer 113, a second binding layer 114, and a packaging layer 115 that are stacked in sequence, where the packaging layer 115 is close to the electrode assembly, and the protective layer 111 is far away from the electrode assembly. The protective layer 111 is made of polymer resin, used to protect the metal layer 113 from being damaged by external force, and capable of preventing air from penetrating inside and maintaining a water- and oxygen-free internal environment for the cell 100. The metal layer 113 is used to prevent water from penetrating inside and protect the cell 100 from being damaged by external force. For example, the metal layer 113 may be specifically an aluminum foil layer. The packaging layer 115 is used to package the packaging film 110 to prevent the packaging film 110 from being dissolved or swelled by an organic solvent in the electrolyte. The packaging layer 115 is further used to prevent an electrolyte salt in the electrolyte from coming into contact with the metal layer 113 and corroding the metal layer 113. The first binding layer 112 is used to bind the protective layer 111 and the metal layer 113. The second binding layer 114 is used to bind the metal layer 113 and the packaging layer 115. In practical applications, the packaging film 110 may be folded in half to form a first packaging film 110a and a second packaging film 110b (shown in FIG. 3). Then, specified temperature and pressure are applied on surfaces of the first packaging film 110a and the second packaging film 110b for heat sealing, so that packaging layers 115 of both the first packaging film 110a and the second packaging film 110b are melted to form the sealing portion 12.

As shown in FIG. 1, the housing body 11 includes a top surface 116, a bottom surface 117, a first side surface 118, and a second side surface 119. The top surface 116 is opposite to the bottom surface 117. The first side surface 118 is opposite to the second side surface 119, and the first side surface 118 and the second side surface 119 are both connected to the top surface 116 and the bottom surface 117. The sealing portion 12 is connected to the top surface 116. A direction from the first side surface 118 to the second side surface 119 is defined as a width direction of the housing 10, and a direction from the bottom surface 117 to the top surface 116 is defined as a length direction of the housing 10. In the width direction of the housing 10, the sealing portion 12 is disposed between the first side surface 118 and the second side surface 119.

A plurality of tabs protrude from the sealing portion 12 to electrically connect to external components. Specifically, the plurality of tabs include a first tab 20 and a second tab 40 that are arranged side by side. The first tab 20 includes a first end (not shown) and a second end 21 that is opposite the first end. The first end is electrically connected to the electrode assembly, and the second end 21 protrudes from the sealing portion 12 to electrically connect to external components. The second tab 40 includes a third end and a fourth end 41 that is opposite the third end. The third end is electrically connected to the electrode assembly, and the fourth end 41 protrudes from the sealing portion 12 to electrically connect to external components.

The first sealant 30 is used to sealably connect the first tab 20 and the sealing portion 12, and a portion of the first sealant 30 is disposed outside the sealing portion 12. The second sealant 50 is used to sealably connect the second tab 40 and the sealing portion 12, and a portion of the second sealant 50 is disposed outside the sealing portion 12. The first sealant 30 is used to prevent a short circuit between the first tab 20 and the metal layer 113 in the packaging film 110 during packaging. In addition, the first sealant 30 is connected to the packaging layer 115 in the packaging film 110 through hot melting during packaging, to prevent electrolyte leakage of the cell 100. Similarly, the second sealant 50 is used to prevent a short circuit between the second tab 40 and the metal layer 113 in the packaging film 110 during packaging. In addition, the second sealant 50 is connected to the packaging layer 115 in the packaging film 110 through hot melting during packaging, to prevent electrolyte leakage of the cell 100.

The sealing portion 12 between the first sealant 30 and the first side surface 118 is a first sealing portion 121, and the sealing portion 12 between the first sealant 30 and the second sealant 50 is a second sealing portion 122. In the length direction of the housing 10, a width W₆ of the first sealing portion 121 is greater than a width W₇ of the second sealing portion 122.

In some embodiments, in the length direction of the housing 10, the width W₆ of the first sealing portion 121 is greater than a width of the sealing portion 12 between the first tab 20 and the second tab 40.

In the prior art, the sealing portion between the first sealant and the first side surface has a lower packaging strength than the sealing portion disposed between the first sealant and the second sealant. When mechanical abuse (for example, drop, collision, and pressing) of the cell occurs, the electrode assembly and the electrolyte easily break this part of sealing portion, leading to a risk of cell failure. In this application, the width of the first sealing portion 121 between the first sealant 30 and the first side surface 118 is made greater than the width of the second sealing portion 122 between the first sealant 30 and the second sealant 50, which increases the width of the sealing portion 12 between the first sealant 30 and the first side surface 118, thereby increasing a sealing strength of this part of sealing portion 12 accordingly. When mechanical abuse of the cell 100 occurs, an impact resistance of the electrode assembly and the electrolyte at this part of sealing portion 12 increases, and a stroke required for the electrode assembly and the electrolyte to fully break this part of sealing portion 12 also increases. This reduces a possibility of breaking this part of sealing portion 12, reduces a risk of failure of the cell 100, and improves safety performance of the cell 100. Further, despite the increased width, the sealing portion 12 between the first sealant 30 and the first side surface 118 does not occupy an inner space of the housing body 11 of the housing 10, thereby avoiding loss of energy density of the cell 100 caused by the increase in the width of this part of sealing portion 12.

As shown in FIG. 1, in some embodiments, in the length direction of the housing 10, an outer periphery of the first sealing portion 121 does not exceed an outer periphery of the second sealing portion 122 exposed outside the first sealant 30. That is, a width W₃ of a portion of the first sealing portion 121 that extends beyond the second sealing portion 122 is less than or equal to a width W₁ of the second sealing portion 122 exposed outside the first sealant 30. In this way, in the length direction of the housing 10, the first sealing portion 121 does not cause an overall length of the housing 10 to increase. Optionally, W₃≤10 mm.

In the width direction of the housing 10, a length L₁ of the first sealing portion 121 is less than a distance between an end of the first sealant 30 that is close to the first side surface 118 to the first side surface 118. In this way, in the width direction of the housing 10, the first sealing portion 121 does not cause an overall width of the housing 10 to increase, thereby avoiding loss of energy density of the cell 100. Optionally, 5 mm≤L₁≤100 mm.

As shown in FIG. 1, in some embodiments, the sealing portion 12 between the second sealant 50 and the second side surface 119 is a third sealing portion 123. In the length direction of the housing 10, a width W₈ of the third sealing portion 123 is greater than the width W₇ of the second sealing portion 122.

In some embodiments, in the length direction of the housing 10, the width W₈ of the third sealing portion 123 is greater than the width of the sealing portion 12 between the first tab 20 and the second tab 40.

In this application, the width of the third sealing portion 123 between the second sealant 50 and the second side surface 119 is made greater than the width of the second sealing portion 122, which increases the width of the sealing portion 12 between the second sealant 50 and the second side surface 119, thereby increasing a sealing strength of this part of sealing portion 12 accordingly. When mechanical abuse of the cell 100 occurs, a possibility of breaking this part of sealing portion 12 is reduced, a risk of failure of the cell 100 is further reduced, and safety performance of the cell 100 is improved. Further, despite the increased width, the sealing portion 12 between the second sealant 50 and the second side surface 119 does not occupy an inner space of the housing body 11, thereby avoiding loss of energy density of the cell 100 caused by the increase in the width of this part of sealing portion 12.

As shown in FIG. 1, in some embodiments, in the length direction of the housing 10, an outer periphery of the third sealing portion 123 does not exceed an outer periphery of the second sealing portion 122 exposed outside the second sealant 50. That is, a width W₄ of a portion of the third sealing portion 123 that extends beyond the second sealing portion 122 is less than or equal to a width W₂ of the second sealing portion 122 exposed outside the second sealant 50. In this way, in the length direction of the housing 10, the third sealing portion 123 does not cause an overall length of the housing 10 to increase. Optionally, W₄≤10 mm.

In the width direction of the housing 10, a length L₂ of the third sealing portion 123 is less than a distance between an end of the second sealant 50 that is close to the second side surface 119 to the second side surface 119. In this way, in the width direction of the housing 10, the third sealing portion 123 does not cause an overall width of the housing 10 to increase, thereby avoiding loss of energy density of the cell 100. Optionally, 5 mm≤L₂≤100 mm.

In some embodiments, the outer periphery of the first sealing portion 121 is substantially aligned with the outer periphery of the second sealing portion 122 exposed outside the first sealant 30. That is, the width W₃ of a portion of the first sealing portion 121 that extends beyond the second sealing portion 122 is equal to the width W₁ the second sealing portion 122 exposed outside the first sealant 30. Also referring to FIG. 3, in the length direction of the housing 10, the first sealing portion 121 extends to edges of the first packaging film 110a and the second packaging film 110b. The width W₄ of a portion of the third sealing portion 123 that extends beyond the second sealing portion 122 is equal to the width W₂ of the second sealing portion 122 exposed outside the second sealant 50. In addition, in the length direction of the housing 10, the third sealing portion 123 may also extend to the edges of the first packaging film 110a and the second packaging film 110b. In this way, on the premise of not occupying a space of the housing 11, the width of the first sealing portion 121 and the width of the third sealing portion 123 are maximized, so that the electrode assembly and the electrolyte receive the largest impact resistance at these parts of sealing portion 12, and the stroke required for the electrode assembly and the electrolyte to break these parts of sealing portion 12 is maximal.

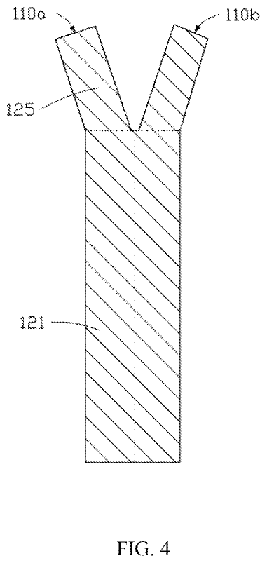

In another embodiment, the width W₃ of a portion of the first sealing portion 121 that extends beyond the second sealing portion 122 may be alternatively less than the width W₁ of the second sealing portion 122 exposed outside the first sealant 30, and the width W₄ of the third sealing portion 123 that exceeds the second sealing portion 122 is less than the width W₂ of the second sealing portion 122 exposed outside the second sealant 50. That is, in the length direction of the housing 10, the first sealing portion 121 and the third sealing portion 123 do not extend to the edge of the packaging film 110. As shown in FIG. 4, in this case, the sealing portion 12 may further include an unsealed portion 125, where the first packaging film 110a and the second packaging film 110b at the unsealed portion 125 are not connected through melting. The unsealed portion 125 is disposed on an outmost surface of the first sealing portion 121 or the third sealing portion 123 in the length direction of the housing 10.

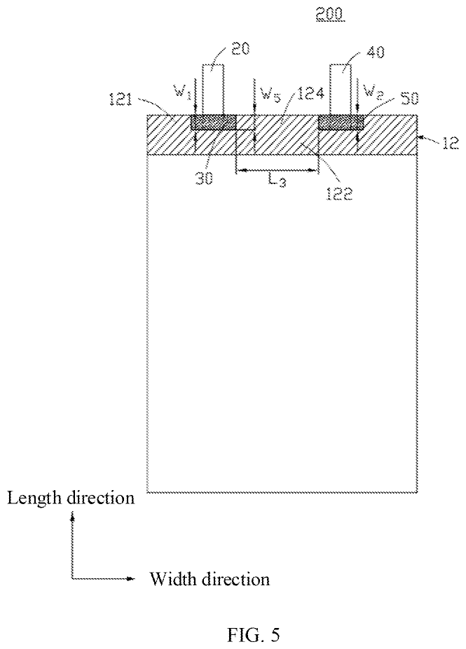

Referring to FIG. 5, another embodiment of this application further provides a cell 200. A difference from the foregoing cell 100 is that a sealing portion 12 further includes a fourth sealing portion 124. In the width direction of a housing 10, the second sealing portion 122 between the first sealant 30 and the second sealant 50 extends along a protrusion direction of the first tab 20 or the second tab 40 to form the fourth sealing portion 124.

In this application, the second sealing portion 122 between the first sealant 30 and the second sealant 50 is made to extend to form the fourth sealing portion 124, which increases a width of the sealing portion 12 between the first sealant 30 and the second sealant 50, thereby increasing a sealing strength of this part of sealing portion 12 accordingly and increasing a sealing strength of the entire sealing portion 12 in a width direction of the cell 200. When mechanical abuse of the cell 200 occurs, a possibility of breaking this part of sealing portion 12 is reduced, a risk of failure of the cell 200 is further reduced, and safety performance of the cell 200 is improved. Further, the fourth sealing portion 124 does not occupy an inner space of the housing body 11, thereby avoiding loss of energy density of the cell 200 caused by the fourth sealing portion 124.

In an embodiment, in the length direction of the housing 10, a width W₅ of the fourth sealing portion 124 is less than or equal to a width W₁ of the second sealing portion 122 exposed outside the first sealant 30, and is less than or equal to a width W₂ of the second sealing portion 122 exposed outside the second sealant 50. In this way, in the length direction of the housing 10, the additional fourth sealing portion 124 does not cause an overall length of the housing 10 to increase. Optionally, W₅≤10 mm.

In an embodiment, in the length direction of the housing 10, a sum of the width of the second sealing portion 122 and a width of the fourth sealing portion 124 is less than the width of the first sealing portion 121 or the third sealing portion 123.

In the width direction of the housing 10, a length L₃ of the fourth sealing portion 124 is less than a distance between an end of the first sealant 30 that is close to the second tab 40 and an end of the second sealant 50 that is close to the first tab 20. In this way, in the width direction of the housing 10, the fourth sealing portion 124 does not cause an overall width of the housing 10 to increase, thereby avoiding loss of energy density of the cell 200. Optionally, 5 mm≤L₃≤100 mm.

The cells 100 and 200 in this application may be all kinds of primary batteries, secondary batteries, fuel batteries, solar batteries, or capacitors (for example, super capacitors). In particular, the secondary batteries may be lithium secondary batteries, including lithium metal secondary batteries, lithium-ion secondary batteries, lithium polymer secondary batteries, and lithium-ion polymer secondary batteries.

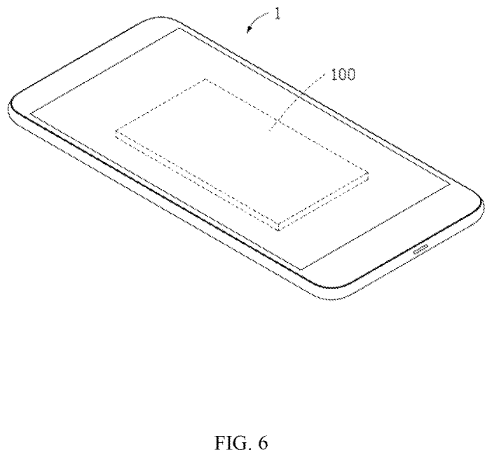

Referring to FIG. 6, an embodiment of this application further provides an electrical apparatus 1, where the electrical apparatus 1 includes the foregoing cell 100 (or the cell 200). In an embodiment, the electrical apparatus 1 of this application may be, but is not limited to, a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a memory card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, a lithium-ion capacitor, or the like.

The following will describe this application in detail with reference to specific examples and comparative examples.

### Example 1

An electrode assembly and an electrolyte were packaged in a housing to obtain a cell. The housing was 90 mm long, 66 mm wide, and 6.1 mm thick. The housing included a housing body and a sealing portion. A first tab and a second tab both protruded from the sealing portion. A first sealant sealed the first tab and the sealing portion, a second sealant sealed the second tab and the sealing portion, and a portion of the first sealant and a portion of the second sealant were disposed outside the sealing portion.

The sealing portion between the first sealant and a first side surface of the housing body was a first sealing portion, the sealing portion between the first sealant and the second sealant was a second sealing portion, and the sealing portion between the second sealant and a second side surface of the housing body was a third sealing portion. In a length direction of the housing, widths of the first sealing portion and the third sealing portion were each greater than a width of the second sealing portion. Lengths of the first sealing portion and the third sealing portion were each 12 mm, and widths of portions of the first sealing portion and the third sealing portion that extended beyond the second sealing portion were each 3 mm.

### Example 2

A difference from Example 1 was that the width of the third sealing portion between the second sealant and the second side surface of the housing body was equal to the width of the second sealing portion.

### Example 3

A difference from Example 1 was that the second sealing portion between the first sealant and the second sealant extended along a protrusion direction of the first tab or the second tab to form a fourth sealing portion.

### COMPARATIVE EXAMPLE

A difference from Example 1 was that the widths of the first sealing portion and the third sealing portion were each equal to the width of the second sealing portion.

Cells in the examples and comparative examples were taken for drop tests, and corresponding drop test results were recorded in the following Table 1. 10 cells were taken from each example and each comparative example for a test. A specific method for the drop test was as follows: First, a voltage of a cell was adjusted to 100% SOC, and a voltage and an internal resistance of the cell before drop were measured after the cell was charged and left to stand for 2 hours. The cell was placed into a clamp bin, a 1 mm silicon rubber pad was placed on a surface of the cell, the cell was pressed by a 5 kg pressure block for 12 h, and then an upper cover plate of the clamp bin was installed. An automatic drop device was used to drop the clamp bin that contained the cell from a position of 1.5 meters to a steel plate, sequentially with a head, a tail, an upper right corner, a lower right corner, an upper left corner, and a lower left corner of the clamp bin touching the steel plate as one round. The drops totaled 6 rounds, that is, 36 drops. After each round of drops, a voltage of the cell was measured. The drops stopped if fire, heating, electrolyte leakage, or a voltage drop of 50 mV or more occurred on the cell. Otherwise, the drops continued until the 6 rounds were completed. After the 6 rounds of drops were completed, the cell was disassembled to collect statistics on the number of broken sealing portions of housings.

TABLE 1

| | Number of broken sealing portions |
|---|---|
| Example 1 | 0/10 |
| Example 2 | 0/10 |
| Example 3 | 0/10 |
| Comparative example | 5/10 |

It can be learned from data in Table 1 that compared with the comparative example, sealing portions of the cells in Examples 1 to 3 all remained unbroken during the drop tests. Therefore, safety of the cells was significantly improved.

The foregoing embodiments are merely intended to describe the technical solutions of this application, but not intended to constitute any limitation. Although this application is described in detail with reference to preferred embodiments, persons of ordinary skill in the art should understand that modifications or equivalent replacements can be made to the technical solutions of this application, without departing from the spirit and essence of the technical solutions of this application.

What is claimed is:

1. A cell, comprising:
an electrode assembly;
a housing comprising a housing body accommodating the electrode assembly and a sealing portion connected to the housing body, wherein the housing body comprises a first side surface and a second side surface opposite to the first side surface, and in a width direction of the housing, the sealing portion is disposed between the first side surface and the second side surface;
a plurality of tabs protruding from the sealing portion, wherein the plurality of tabs comprise a first tab and a second tab arranged side by side;
a first sealant sealably connecting the first tab and the sealing portion, wherein a portion of the first sealant is disposed outside the sealing portion; and
a second sealant sealably connecting the second tab and the sealing portion, wherein a portion of the second sealant is disposed outside the sealing portion;
wherein,
the sealing portion between the first sealant and the first side surface is a first sealing portion, the sealing portion between the first sealant and the second sealant is a second sealing portion, and in a length direction of the housing, a width of the first sealing portion is greater than a width of the second sealing portion.

2. The cell according to claim 1, wherein, in the length direction of the housing, an outer periphery of the first sealing portion does not exceed an outer periphery of the second sealing portion exposed outside the first sealant.

3. The cell according to claim 1, wherein, in the length direction of the housing, the width of the first sealing portion is greater than a width of the sealing portion between the first tab and the second tab.

4. The cell according to claim 1, wherein the sealing portion between the second sealant and the second side surface is a third sealing portion, and in the length direction of the housing, a width of the third sealing portion is greater than the width of the second sealing portion.

5. The cell according to claim 4, wherein, in the length direction of the housing, an outer periphery of the third sealing portion does not exceed an outer periphery of the second sealing portion exposed outside the second sealant.

6. The cell according to claim 5, wherein, in the length direction of the housing, the width of the third sealing portion is greater than a width of the sealing portion between the first tab and the second tab.

7. The cell according to claim 4, wherein the sealing portion further comprises a fourth sealing portion, and in the width direction of the housing, the second sealing portion between the first sealant and the second sealant extends along a protrusion direction of the first tab or the second tab to form the fourth sealing portion.

8. The cell according to claim 7, wherein, in the length direction of the housing, a width of the fourth sealing portion is less than or equal to a width of the second sealing portion exposed outside the first sealant, and is less than or equal to a width of the second sealing portion exposed outside the second sealant; and in the width direction of the housing, a length of the fourth sealing portion is less than a distance between an end of the first sealant close to the second tab and an end of the second sealant close to the first tab.

9. The cell according to claim 7, wherein, in the length direction of the housing, a sum of the width of the second sealing portion and a width of the fourth sealing portion is less than the width of the first sealing portion or the third sealing portion.

10. An electrical apparatus, comprising a cell, the cell comprising:
an electrode assembly;
a housing comprising a housing body accommodating the electrode assembly and a sealing portion connected to the housing body, wherein the housing body comprises a first side surface and a second side surface opposite to the first side surface, and in a width direction of the housing, the sealing portion is disposed between the first side surface and the second side surface;
a plurality of tabs protruding from the sealing portion, wherein the plurality of tabs comprise a first tab and a second tab arranged side by side;
a first sealant sealably connecting the first tab and the sealing portion, wherein a portion of the first sealant is disposed outside the sealing portion; and
a second sealant sealably connecting the second tab and the sealing portion, wherein a portion of the second sealant is disposed outside the sealing portion; wherein
the sealing portion between the first sealant and the first side surface is a first sealing portion, the sealing portion between the first sealant and the second sealant is a second sealing portion, and in a length direction of the housing, a width of the first sealing portion is greater than a width of the second sealing portion.

11. The electrical apparatus according to claim 10, wherein, in the length direction of the housing, an outer periphery of the first sealing portion does not exceed an outer periphery of the second sealing portion exposed outside the first sealant.

12. The electrical apparatus according to claim 10, wherein, in the length direction of the housing, the width of the first sealing portion is greater than a width of the sealing portion between the first tab and the second tab.

13. The electrical apparatus according to claim 10, wherein the sealing portion between the second sealant and the second side surface is a third sealing portion, and in the length direction of the housing, a width of the third sealing portion is greater than the width of the second sealing portion.

14. The electrical apparatus according to claim 13, wherein, in the length direction of the housing, an outer periphery of the third sealing portion does not exceed an outer periphery of the second sealing portion exposed outside the second sealant.

15. The electrical apparatus according to claim 14, wherein, in the length direction of the housing, the width of the third sealing portion is greater than a width of the sealing portion between the first tab and the second tab.

16. The electrical apparatus according to claim 13, wherein the sealing portion further comprises a fourth sealing portion, and in the width direction of the housing, the second sealing portion between the first sealant and the second sealant extends along a protrusion direction of the first tab or the second tab to form the fourth sealing portion.

17. The electrical apparatus according to claim 16, wherein, in the length direction of the housing, a width of the fourth sealing portion is less than or equal to a width of the second sealing portion exposed outside the first sealant, and is less than or equal to a width of the second sealing portion exposed outside the second sealant; and in the width direction of the housing, a length of the fourth sealing portion is less than a distance between an end of the first sealant close to the second tab and an end of the second sealant close to the first tab.

18. The electrical apparatus according to claim 16, wherein, in the length direction of the housing, a sum of the width of the second sealing portion and a width of the fourth sealing portion is less than the width of the first sealing portion or the third sealing portion.
